(19) United States
(12) Patent Application Publication
(10) Pub. No.: US 2005/0137086 A1
(43) Pub. Date: Jun. 23, 2005

(54) Fuel reforming catalyst

(75) Inventor: Noboru Yamauchi, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/012,195

(22) Filed: Dec. 16, 2004

(30) Foreign Application Priority Data
Dec. 19, 2003 (JP) P 2003-422188

(51) Int. Cl. B01J 23/00

(52) U.S. Cl. 502/439

(57) ABSTRACT

A fuel reforming catalyst of the present invention has a metal substrate including a passage-forming portion which is stacked on a flat metal plate and forms a large number of passages, and a catalytic component supported in the metal substrate. In the fuel reforming catalyst, the passage-forming portion has a plurality of cells, the cells are arrayed at a predetermined interval in a direction substantially perpendicular to a fuel gas flowing direction so as to form a cell group, a plurality of the cell groups are provided on the passage-forming portion toward the fuel gas flowing direction, and the cells adjacent to one another in the fuel gas flowing direction are shifted from one another in the direction substantially perpendicular to the fuel gas flowing direction by a predetermined distance.

### BACKGROUND OF THE INVENTION

1. Field of the Invention

The present invention relates to a fuel reforming catalyst for use in a reformer which generates hydrogen-enriched gas from gasoline.

2. Description of the Related Art

A fuel cell vehicle which mounts thereon a fuel cell operating by use of hydrogen-enriched gas generated by reforming gasoline by a fuel reforming system has attracted attention in recent years. Such a fuel cell vehicle has features that the existing fuel infrastructure is usable, that a cruising distance can be prolonged because an amount of energy (energy density) per volume of the gasoline is large (high), and the like. However, the fuel cell vehicle has a drawback that a size of the fuel reforming system becomes enlarged so much that mountability of the fuel cell on the fuel cell vehicle becomes deteriorated in the case of using a plant technology at present. Moreover, such enlargement in size of the fuel reforming system also increases a heat capacity of the fuel cell. Therefore, the fuel cell vehicle also has drawbacks that the fuel cell requires much energy for activation, and that it also takes longer to activate the fuel cell.

Accordingly, various attempts to downsize the fuel reforming system have been made. In a fuel reforming catalyst for use in a reformer which generates the hydrogen-enriched gas from the gasoline, such attempts have been made, in which a substrate (corrugated-fin substrate) composed by combining a flat metal plate and a corrugated metal plate is used, and a substrate composed of foam metal is used. Use of such materials can downsize the size of the fuel reforming system more than that of a conventional catalyst including a ceramic honeycomb substrate (refer to “New Material Changes Automobile (original title is in Japanese)”, edited by Materials Research Laboratory of Nissan Research Center, Nissan Motors Co., Ltd., and to Nikkei Mechanical, vol. 561, issued in June 2001).

### SUMMARY OF THE INVENTION

However, in the case of a fuel reforming catalyst using the above-described corrugated-fin substrate, a surface of the catalyst is continuously present along a gas flow, and accordingly, a thermal boundary layer is undesirably formed in the vicinity of the catalyst surface. Such a thermal boundary layer starts to grow from each inlet of gas passages, and continuously grows in a direction of the passages. In particular, a steam reforming reaction involves large endotherm, and thus the thermal boundary layer is apt to grow, and temperature of the catalyst surface is rather lowered than temperature of the gas, causing lowering of a reaction rate.

Meanwhile, in the case of a fuel reforming catalyst using the foam metal for the substrate, the gas passages are configured three-dimensionally, and accordingly, it is conceived that the thermal boundary layer is difficult to grow and a high reaction rate is realizable. However, in the fuel reforming catalyst using the foam metal, the gas passages are complicated, and accordingly, there is a problem that clogging occurs in the gas passages when a catalytic component is coated thereon, resulting in lowering of catalyst performance. In this case, diameter of pores of the foam metal is enlarged, and the coated catalytic component is thinned, thus making it possible to prevent the clogging of the gas passages to some extent. However, the catalyst performance becomes lowered by the amount of the enlargement of the pores of the foam metal and the thinning of the catalytic component. Hence, the fuel reforming catalyst using the foam metal for the substrate has limitations on improvement of the catalyst performance.

The present invention has been created focusing on the above-described conventional problems. It is an object of the present invention to provide a fuel reforming catalyst, which can realize compactness and the high reaction rate, can further restrict the clogging of the gas passages from occurring when the catalytic component is coated thereon, and is consequently capable of coating a large amount of the catalytic component thereon.

The first aspect of the present invention provides a fuel reforming catalyst comprising: a metal substrate including a passage-forming portion which is stacked on a flat metal plate and forms a large number of passages; and a catalytic component supported in the metal substrate, wherein the passage-forming portion has a plurality of cells, the cells are arrayed at a predetermined interval in a direction substantially perpendicular to a fuel gas flowing direction so as to form a cell group, a plurality of the cell groups are provided on the passage-forming portion toward the fuel gas flowing direction, and the cells adjacent to one another in the fuel gas flowing direction are shifted from one another in the direction substantially perpendicular to the fuel gas flowing direction by a predetermined distance.

The second aspect of the present invention provides a fuel reforming catalyst comprising: a plurality of metal substrates mutually different in number of cells or shape of the cells; and a catalytic component supported in the metal substrates, wherein the plurality of metal substrates are stacked on one another along a fuel gas flowing direction.

### BRIEF DESCRIPTION OF THE DRAWINGS

The invention will now be described with reference to the accompanying drawings wherein;

FIG. 1 is a perspective view showing a substrate for use in a fuel reforming catalyst of the present invention;

FIG. 2 is a front view of the substrate of FIG. 1;

FIG. 3 is a perspective view showing a passage-forming portion of the substrate of FIG. 1;

FIG. 4A is a schematic view showing thermal boundary layers when the fuel reforming catalyst of the present invention is used;

FIG. 4B is a schematic view showing a thermal boundary layer when a conventional corrugated-fin substrate is used;

FIGS. 5A and 5B are perspective views showing another example of the substrate for use in the fuel reforming catalyst of the present invention;

FIGS. 6A and 6B are perspective views showing still another example of the substrate for use in the fuel reforming catalyst of the present invention;

FIGS. 7A and 7B are perspective views showing yet another example of the substrate for use in the fuel reforming catalyst of the present invention; and

FIG. 8 is a graph showing performance evaluation results of Examples and Comparative Examples.

### DETAILED DESCRIPTION OF THE PREFERRED EMBODIMENT

Hereinafter, description will be made of embodiments of the present invention with reference to the drawings.

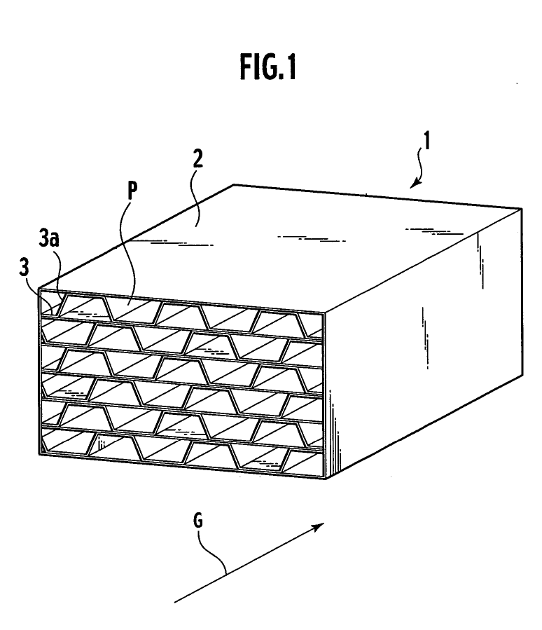

A fuel reforming catalyst of the present invention is suitable for use in a chemical reaction involving endotherm. As shown in FIGS. 1 to 3, the fuel reforming catalyst is composed of a substrate 1 and a catalytic component 4. The catalytic component 4 is coated on an inner surface of the substrate 1 entirely. Then, when fuel gas passes through an inside of the substrate 1, the fuel gas is reformed into hydrogen-enriched gas by the catalytic component 4. Moreover, as described later, such a fuel reforming reaction is an endothermic reaction, and accordingly, it is necessary to supply thermal energy to the reforming catalyst. In order to conduct the thermal energy efficiently to the entire catalyst, it is preferable to use a metal substrate for the substrate of the reforming catalyst.

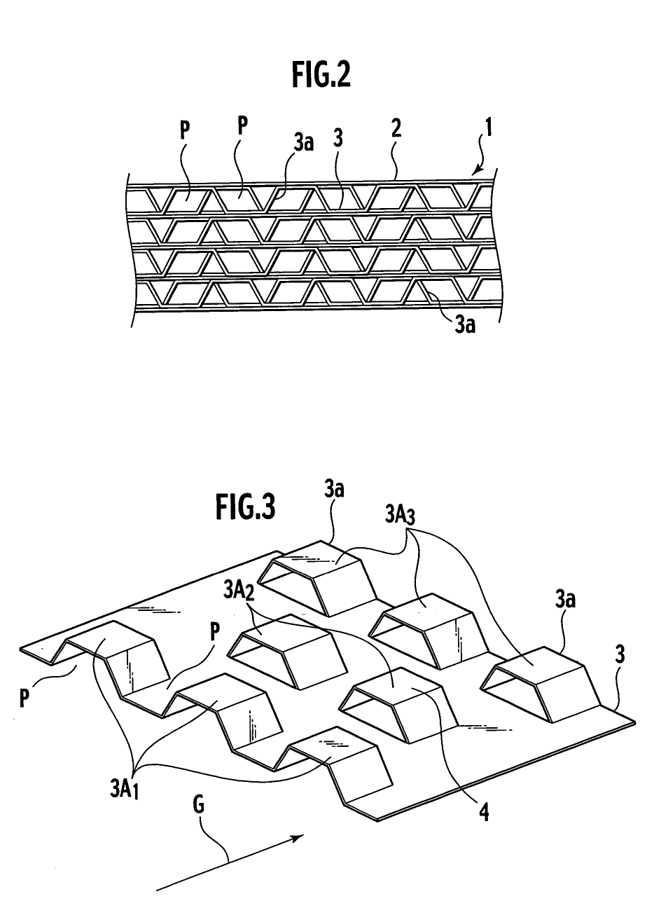

As shown in FIGS. 1 and 2, the substrate 1 for use in the present invention has a passage-forming portion 3 which is stacked on a flat metal plate 2 and forms a large number of passages P. The passage-forming portion 3 has a plurality of cells 3a, and forms the passages P by arranging these cells 3a on the flat metal plate 2 at an appropriate interval in a zigzag manner. Specifically, the plurality of cells 3a are arrayed at a predetermined interval in a direction substantially perpendicular to a fuel gas flowing direction G, thus forming a cell group 3A1. Then, a plurality of the cell groups 3A1 are formed toward the flowing direction G (cell groups 3A2, 3A3 . . . ). Furthermore, the cells 3a adjacent to one another in the flowing direction G are shifted from one another in the direction substantially perpendicular to the flowing direction G by a predetermined distance.

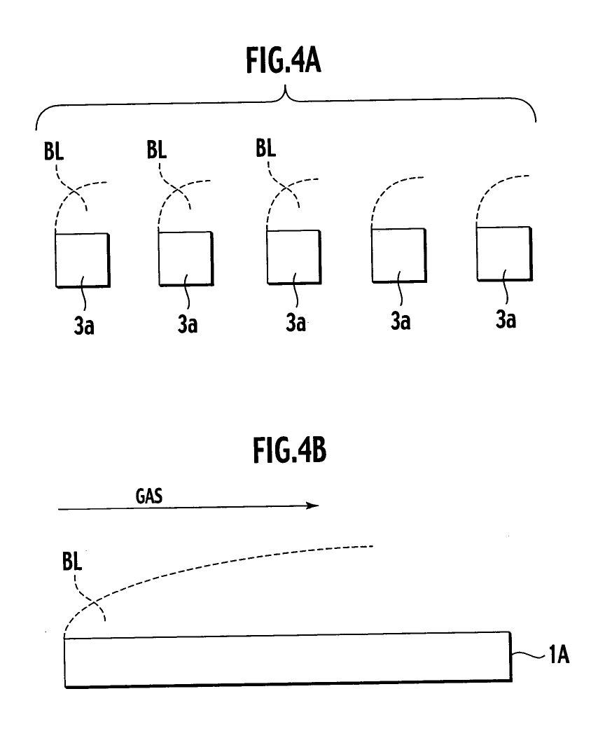

When the plurality of cells 3a in the metal substrate 1 are arranged as described above on the flat metal plate 2 at the predetermined interval in the zigzag manner, the plurality of cells 3a become discontinuous with respect to the flowing direction G. Therefore, as shown in FIG. 4A, thermal boundary layers BL start to grow in the respective cells 3a, and the thermal boundary layers BL stop growing on portions where the cells 3a are not present. Hence, such development of the thermal boundary layer BL in each end of the respective cells 3a becomes smaller than that of a thermal boundary layer BL which continuously grows on a conventional corrugated-fin substrate 1A (refer to FIG. 4B).

Specifically, as shown in Formula 1, a steam reforming reaction of isooctane is an endothermic reaction. Therefore, when high-temperature fuel gas (isooctane) is introduced into the catalyst, a surface of the catalyst is cooled down by the endothermic reaction, and accordingly, a temperature difference between the catalyst surface and a gas layer is increased to develop the thermal boundary layer.
i−C₈H₁₈+8H₂O→17H₂+8CO ΔH=1274.5 kJmol⁻¹ (Formula 1)

In general, a reaction rate of a chemical reaction is increased as temperature is higher. However, because of the development of the thermal boundary layer, the heat of the gas layer does not sufficiently transferred to the catalyst surface, and as a result, the reaction rate is lowered. Hence, if the metal substrate 1 as the substrate for the above-described catalytic component is adopted, the endothermic reaction can be accelerated.

Note that the cells 3a of the passage-forming portion 3 in the metal substrate 1 can be fabricated in a manner that a flat metal plate is first stamped out and then pressed. Use of such a method can reduce manufacturing cost of the substrate.

The above-described metal honeycomb substrate 1 having the cells 3a arranged in the zigzag manner has a feature that the adjacent cells in the fuel gas flowing direction G are shifted from one another by the predetermined distance. Specifically, unlike a conventional corrugated-fin substrate, the cells of the substrate of the present invention do not form through holes from inlet of the substrate to outlet thereof while keeping a fixed shape. Moreover, unlike the conventional corrugated-fin substrate, the cells of the substrate of the present invention do not form continuous through holes from the inlet of the substrate to the outlet thereof. Hence, the configuration of the substrate 1 is not limited to the one described above. If a substrate which has cells different in shape from the inlet of the substrate to the outlet thereof is used, or if a substrate which does not have the continuous through holes formed from the inlet of the substrate to the outlet thereof is used, then a similar effect to that of the substrate 1 can be obtained.

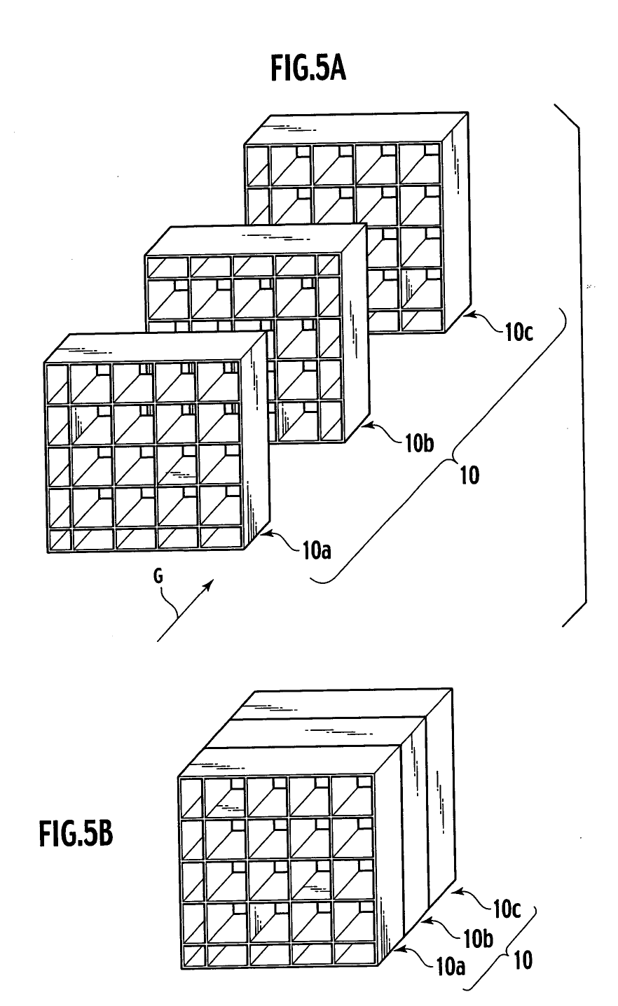

Specifically, as shown in FIGS. 5A and 5B, a substrate 10 can be used, in which a plurality of metal substrates 10a, 10b and 10c are stacked on one another in the gas flowing direction G such that positions of cells thereof are shifted from one another. Like the substrate 1, the substrate 10 does not form the through holes from the inlet of the substrate to the outlet thereof while keeping a fixed shape. Hence, the thermal boundary layers can be prevented from growing, and the fuel gas can be diffused efficiently in the substrate.

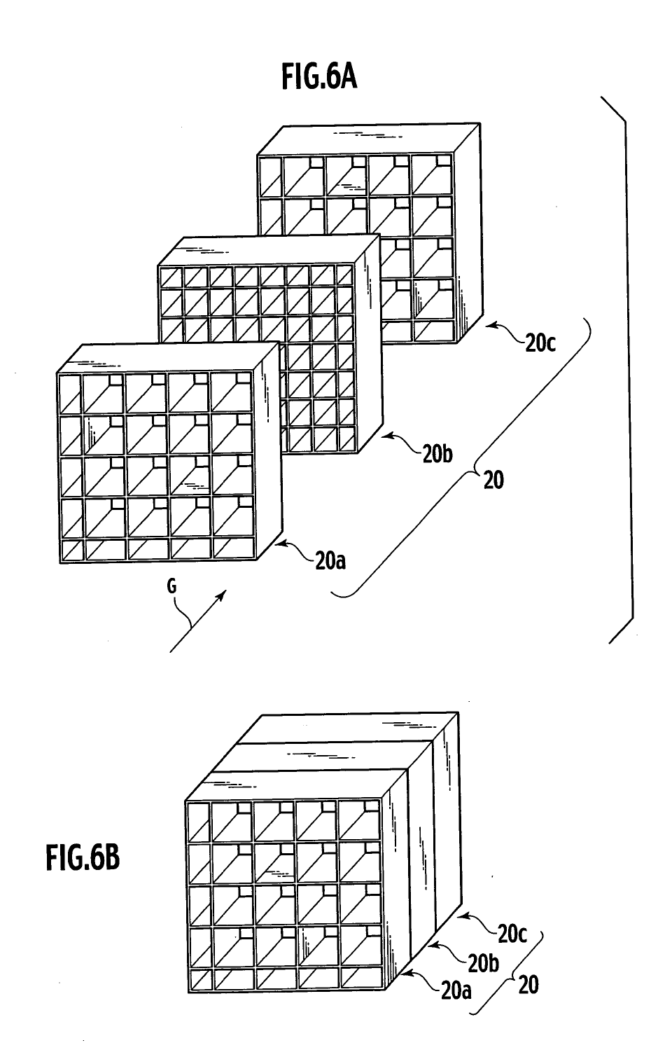

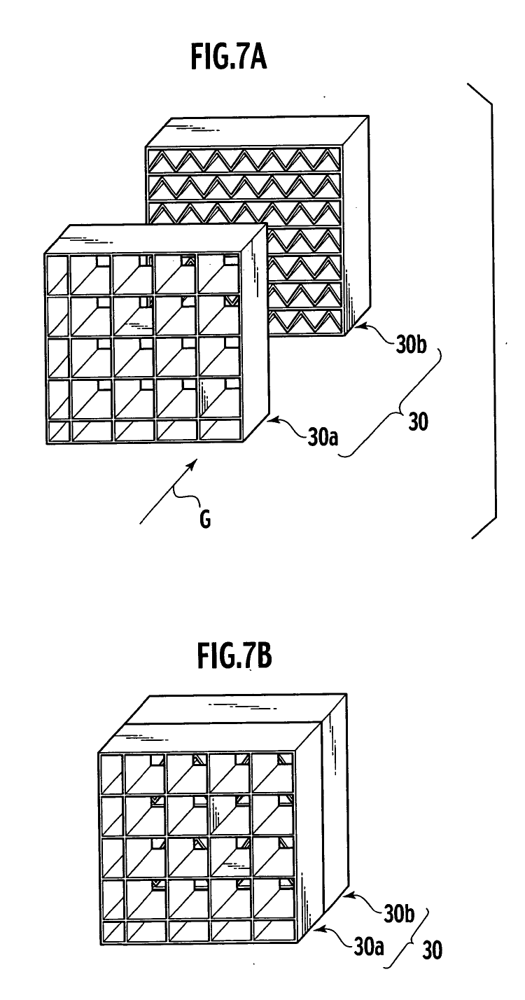

Moreover, as shown in FIGS. 6A and 6B, a substrate 20 can be used, in which metal substrates 20a, 20b and 20c mutually different in number of the cells are stacked on one another in the gas flowing direction G. Furthermore, as shown in FIGS. 7A and 7B, a substrate 30 can be used, in which metal substrates 30a and 30b having cells mutually different in shape are stacked on each other in the gas flowing direction G. As shapes of the cells, triangular, rectangular, hexagonal, wavy and other shapes can be used. Even in the case of using such substrates, like the substrate 1, the thermal boundary layers can be prevented from growing, and the fuel gas can be diffused efficiently in the substrates.

In the fuel reforming catalyst of the present invention, at least hydrocarbon and water are used as materials for generating the hydrogen-enriched gas, and the hydrocarbon is reformed by the steam reforming reaction. Preferably, at least hydrocarbon, water, and either air or oxygen are used as the materials for generating the hydrogen-enriched gas, and the hydrocarbon is reformed by the steam reforming reaction. In this case, heat required for the endothermic reaction can be obtained in the same reactor, and accordingly, a system which supplies the heat can be omitted.

Moreover, the fuel reforming catalyst of the present invention is completed in a manner that slurry which contains the catalytic component is applied on the substrate, followed by drying and baking thereof. Hence, on the fuel reforming catalyst of the present invention, it is possible to evenly coat the catalytic component without purposely changing a coating method of the catalytic component from a conventional one, thus enabling effective utilization of the existing facilities. In this case, a preparation method of the slurry which contains the catalytic component is not changed from a conventional preparation method, either.

Moreover, in the fuel reforming catalyst of the present invention, it is preferable that rhodium (Rh) be contained in the catalytic component. In this case, hydrocarbon can be reformed at high speed without involving generation of soot, and accordingly, it is possible to reduce a catalyst volume.

Furthermore, in the fuel reforming catalyst of the present invention, it is preferable that at least one of alumina (Al₂O₃), titania (TiO₂), zirconia (ZrO₂) and ceria (CeO₂), as well as Rh, be contained in the catalytic component. Use of such a carrier can accelerate the steam reforming reaction which is the endothermic reaction, and accordingly, the catalyst volume can be reduced.

Here, in the case of containing Rh in the catalytic component, a usage of the Rh is preferably within a range from 0.5 to 20 g, and more preferably, 1 to 4 g per 1 liter of the substrate. When the usage of Rh is too little, sufficient catalytic activity cannot be obtained, and when the usage is too much, cost of the fuel reforming catalyst is increased.

Moreover, in the case of containing Rh in the catalytic component, a concentration of the Rh in the catalyst is preferably within a range from 1 to 6% by weight, and more preferably, 2 to 4% by weight per catalytic component. When the concentration of Rh in the catalyst is too high, aggregation of Rh particles occur, and the performance of the catalyst is lowered. As opposed to this, when the concentration of Rh in the catalyst is too low, it becomes necessary to increase a coating amount of the catalyst in order to ensure an amount of Rh required for the reaction. In this case, thickness of the coated layer is increased, the catalyst deep inside the layer becomes unutilized, and these are not preferable.

A coated amount of the catalyst is preferably within a range from 50 to 200 g, and more preferably, 50 to 100 g per 1 liter of the substrate. In the case where the usage of Rh is constant, it is necessary to increase the concentration of Rh when the coated amount is too little, and an influence of the aggregation of the Rh particles is increased. As opposed to this, when the coated amount is too much, the thickness of the coated layer is increased, the catalyst deep inside the layer becomes unutilized, and these are not preferable.

The present invention is described below based on Examples, and however, the present invention is not limited to the Examples to be described below.

### EXAMPLES 1 TO 3

With regard to the metal substrate 1 shown in FIG. 1, three types different in number of the cells (900, 1100 and 1800 cpsi) were prepared. Then, the slurry which contained the catalytic component 4 was applied on the respective substrates, followed by the drying and baking thereof, and thus fuel reforming catalysts 1 to 3 of Examples 1 to 3 were obtained. The catalytic component which mainly contained Al₂O₃ and 4% by weight of rhodium was used, and 60 g of the catalytic component was coated per 1 liter of any of the substrates.

### COMPARATIVE EXAMPLES 1 to 3

As substrates for comparison, a ceramic honeycomb substrate (900 cpsi), a corrugated-type metal substrate (900 cpsi) and foam metal (900 cpsi) were prepared. Like the Examples 1 to 3, the slurry which contained the catalytic component 4 was applied on the respective substrates, followed by the drying and baking thereof, and thus fuel reforming catalysts 1 to 3 of Comparative Examples 1 to 3 were obtained. Note that each of the ceramic honeycomb substrate and the corrugated-type metal substrate, which were used in the Comparative Examples, is one in which the cells form the through holes continuously from the inlet of the substrate to the outlet thereof while keeping a fixed shape.

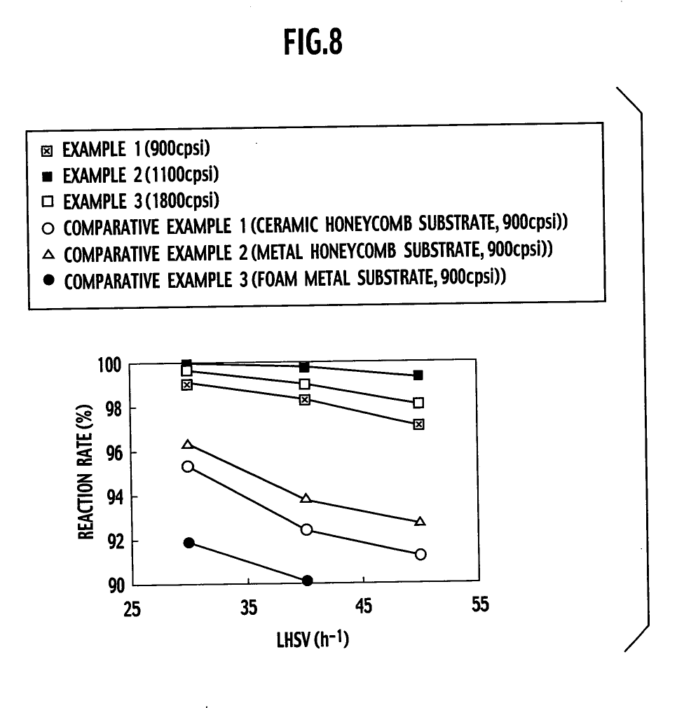

An experiment for investigating fuel reaction rates was performed for the fuel reforming catalysts of the Examples and the fuel reforming catalyst of the Comparative Examples, and results shown in FIG. 8 were obtained. Fuel used for the experiment was desulfurized gasoline, and experimental conditions were as follows. Temperature of supplied gas was 500° C., a ratio of H₂O to C was equal to 1.5, and a ratio of O₂ to C was 0.4. Here, “C” denotes the number of carbon atoms in the fuel. Specifically, when the number of moles of the fuel is x and an average number of carbons in molecules constituting the fuel is a, “C” is obtained from ax. Note that LHSV in the graph is an abbreviation of “Liquid Hourly Space Velocity”, and represents space velocity of the supplied fuel. The LHSV is obtained from the following Expression 1.

$$LHSV = \frac{\text{Supply speed of fuel(liquid)} ( {Lh}^{- 1} )}{\text{Catalyst volume} ( L )} \qquad ( Expression 1 )$$

Moreover, cpsi in the graph is an abbreviation of “Cells per Square Inch”, and represents the number of cells per square inch of the metal substrate of the foam metal.

The reason that oxygen (air) was added in the experiment is for compensating endotherm of the steam reforming reaction by heat generation caused by a burning reaction of the oxygen and the fuel. Actually, the fuel is rich, and accordingly, it is estimated that a so-called partial oxidation reaction occurs. The reaction of the oxygen and the fuel has a much faster reaction rate than the steam reforming reaction, and is almost completed at the most upstream portion of the catalyst layer. Accordingly, the majority of the catalyst layer will be in charge of the steam reforming reaction. Hence, even if the oxygen is added to the material, a large difference does not occur basically from the case of only the steam reforming reaction.

As shown in FIG. 8, with regard to the reaction rate of the fuel, the fuel reforming catalysts of the Examples were superior to the fuel reforming catalysts of the Comparative Examples, and similar tendencies were shown also in other experimental conditions. From this, it was able to be proven that the fuel reforming catalyst of the present invention had an excellent fuel reaction rate as compared with the fuel reforming catalyst using the foam metal as the substrate.

Although the desulfurized gasoline was used in this experiment, the steam reforming reaction of the hydrocarbon fuel is the endothermic reaction, and accordingly, a similar effect can be obtained whatever fuel may be used. Moreover, also in an endothermic reaction other than the steam reforming reaction, a similar effect can be obtained when the endotherm is sufficiently large though the effect varies to some extent.

The entire content of a Japanese Patent Application No. P2003-422188 with a filing date of Dec. 19, 2003 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

1. A fuel reforming catalyst, comprising:
a metal substrate including a passage-forming portion which is stacked on a flat metal plate and forms a large number of passages; and
a catalytic component supported in the metal substrate,
wherein the passage-forming portion has a plurality of cells,
the cells are arrayed at a predetermined interval in a direction substantially perpendicular to a fuel gas flowing direction so as to form a cell group,
a plurality of the cell groups are provided on the passage-forming portion toward the fuel gas flowing direction, and
the cells adjacent to one another in the fuel gas flowing direction are shifted from one another in the direction substantially perpendicular to the fuel gas flowing direction by a predetermined distance.

2. The fuel reforming catalyst of claim 1,
wherein the passage-forming portion is composed of a flat metal plate, and
the cells are formed in a manner that the flat metal plate is stamped out and then pressed.

3. The fuel reforming catalyst of claim 1,
wherein hydrocarbon and water are contained in the fuel gas introduced into the catalyst.

4. The fuel reforming catalyst of claim 3,
wherein air or oxygen is contained in the fuel gas.

5. The fuel reforming catalyst of claim 1,
wherein rhodium is contained in the catalytic component.

6. The fuel reforming catalyst of claim 5,
wherein at least one of alumina, titania, zirconia and ceria is contained in the catalytic component.

7. A fuel reforming catalyst, comprising:
a plurality of metal substrates mutually different in number of cells or shape of the cells; and
a catalytic component supported in the metal substrates,
wherein the plurality of metal substrates are stacked on one another along a fuel gas flowing direction.

8. The fuel reforming catalyst of claim 7,
wherein hydrocarbon and water are contained in the fuel gas introduced into the catalyst.

9. The fuel reforming catalyst of claim 8,
wherein air or oxygen is contained in the fuel gas.

10. The fuel reforming catalyst of claim 7,
wherein rhodium is contained in the catalytic component.

11. The fuel reforming catalyst of claim 10,
wherein at least one of alumina, titania, zirconia and ceria is contained in the catalytic component.
